(19) United States
(12) Patent Application Publication
(10) Pub. No.: US 2019/0279037 A1
(43) Pub. Date: Sep. 12, 2019

(54) MULTI-TASK RELATIONSHIP LEARNING SYSTEM, METHOD, AND PROGRAM

(71) Applicant: NEC Corporation, Minato-ku, Tokyo (JP)

(72) Inventors: Akira TANIMOTO, Tokyo (JP); Yousuke MOTOHASHI, Tokyo (JP); Ryohei FUJIMAKI, Tokyo (JP)

(73) Assignee: NEC Corporation, Minato-ku, Tokyo (JP)

(21) Appl. No.: 16/346,579

(22) PCT Filed: Nov. 8, 2016
(86) PCT No.: PCT/JP2016/083112

§ 371 Date: May 1, 2019

(51) Int. Cl. G06K 9/62; G06N 20/00

(52) U.S. Cl. CPC G06K 9/6257; G06N 20/00; G06K 2009/6237; G06K 9/6235; G06K 9/6215

(57) ABSTRACT

A multi-task relationship learning system 80 for simultaneously estimating a plurality of prediction models includes a learner 81 for optimizing the prediction models so as to minimize a function that includes a sum total of errors indicating consistency with data and a regularization term deriving sparsity relating to differences between the prediction models, to estimate the prediction models.

### TECHNICAL FIELD

The present invention relates to a multi-task relationship learning system, a multi-task relationship learning method, and a multi-task relationship learning program for simultaneously learning a plurality of tasks.

### BACKGROUND ART

Multi-task learning is a technique of simultaneously learning a plurality of related tasks to improve the prediction accuracy of each task. Through multi-task learning, factors common to related tasks can be acquired. Hence, for example even in the case where learning samples of target tasks are very few, prediction accuracy can be improved.

As a method of learning in a state in which similarity between tasks is not clearly given, multi-task relationship learning as described in Non Patent Literature (NPL) 1 is known. With the learning method described in NPL 1, prediction models of a plurality of targets are estimated by solving an optimization problem including a viewpoint of consistency with data, a viewpoint that prediction models are more similar when prediction targets are more similar, and a viewpoint that a target group is preferably from fewer clusters.

### CITATION LIST

### Non Patent Literature

NPL 1: A. Argyriou, et al., “Learning the Graph of Relations Among Multiple Tasks”, ICML 2014 workshop on New Learning Frameworks and Models for Big Data, 2013.

### SUMMARY OF INVENTION

### Technical Problem

The method described in NPL 1 will be explained below, as existing multi-task relationship learning. FIG. 5 is an explanatory diagram depicting an operation example of estimating prediction models by multi-task relationship learning. When past data {X,Y} is input to a learner 61 as learning data, the learner 61 generates a matrix Q indicating inter-task similarity and a matrix W indicating a plurality of prediction models, and outputs them. A predictor 62 applies prediction data for an explanatory variable xᵢ included in a prediction model of a task i to the generated prediction model, and outputs a prediction result yᵢ.

FIG. 6 is an explanatory diagram depicting an example of the matrix W indicating the generated prediction models. In the example depicted in FIG. 6, each column of the matrix W indicates a prediction model for one prediction target (task). Specifically, the tasks representing the prediction targets are arranged in the row direction of the matrix W, and the attributes applied to the prediction models are arranged in the column direction of the matrix W.

FIG. 7 is a flowchart depicting an operation example of multi-task relationship learning. The learner 61 initializes the matrix W and the matrix Q (step S61). As mentioned above, W is a matrix representing a linear prediction model group, and each column vector w corresponds to a prediction model for one task (prediction target).

Q is a matrix obtained by adding a ε* unit matrix for stabilization to a graph Laplacian matrix generated based on a similarity matrix representing inter-task similarity. Since Q is not clearly given in multi-task relationship learning, the learner 61 optimizes Q along with W.

The learner 61 receives input of hyper parameters λ₁ and λ₂ (step S62). In the below-described process, λ₁ is a parameter indicating an effect of making prediction models closer to each other between tasks. When λ₁ is higher, this effect is stronger. λ₂ is a parameter controlling the number of clusters. When λ₂ is higher, tasks form fewer clusters through Q.

First, the learner 61 fixes Q and optimizes W (step S63). For example, the learner 61 optimizes W so as to minimize the expression of the following Expression 1. In Expression 1, “Σ error” is a term representing consistency with data, and is, for example, a square error.

$$\begin{matrix}[ Math . 1 ] & \\ {min}_{W} ( \sum error + {λ}_{1} tr ( {W}^{T} QW ) ) & Expression ( 1 )\end{matrix}$$

Next, the learner 61 fixes W and optimizes Q (step S64). For example, the learner 61 optimizes Q so as to minimize the expression of the following Expression 2.

$$\begin{matrix}[ Math . 2 ] & \\ {min}_{Q} ( {λ}_{1} tr ( {W}^{T} QW ) + {λ}_{2} tr ( {Q}^{- 1} ) ) & Expression ( 2 )\end{matrix}$$

The learner 61 determines the convergence of the optimization process based on the update width, the lower limit variation, and the like (step S65). In the case where the learner 61 determines that the optimization process has converged (step S65: Yes), the learner 61 outputs W and Q (step S66), and ends the process. In the case where the learner 61 determines that the optimization process has not converged (step S65: No), the learner 61 repeats the process from step S63.

Thus, in the multi-task relationship learning described in NPL 1, etc., the step of optimizing the matrix Q and the step of optimizing the matrix W are performed alternately, to simultaneously learn the plurality of prediction models. However, as can be seen from Expressions 1 and 2, the order of computational complexity of each optimization step is the order of the cube of the number of tasks (O((the number of tasks)³)), and the order of memory required is the order of the square of the number of tasks (O((the number of tasks)²)).

It is therefore virtually impossible to use the above-described learning method in the case of simultaneously learning a large number of prediction models.

The present invention has an object of providing a multi-task relationship learning system, a multi-task relationship learning method, and a multi-task relationship learning program that can improve the accuracy of a plurality of estimated prediction models while reducing computational complexity in prediction model learning.

### Solution to Problem

A multi-task relationship learning system according to the present invention is a multi-task relationship learning system for simultaneously estimating a plurality of prediction models, the multi-task relationship learning system including a learner which optimizes the prediction models so as to minimize a function that includes a sum total of errors indicating consistency with data and a regularization term deriving sparsity relating to differences between the prediction models, to estimate the prediction models.

A multi-task relationship learning method according to the present invention is a multi-task relationship learning method for simultaneously estimating a plurality of prediction models, the multi-task relationship learning method including optimizing the prediction models so as to minimize a function that includes a sum total of errors indicating consistency with data and a regularization term deriving sparsity relating to differences between the prediction models, to estimate the prediction models.

A multi-task relationship learning program according to the present invention is a multi-task relationship learning program for use in a computer for simultaneously estimating a plurality of prediction models, the multi-task relationship learning program causing the computer to execute a learning process of optimizing the prediction models so as to minimize a function that includes a sum total of errors indicating consistency with data and a regularization term deriving sparsity relating to differences between the prediction models, to estimate the prediction models.

### Advantageous Effects of Invention

According to the present invention, the accuracy of a plurality of estimated prediction models can be improved while reducing computational complexity in prediction model learning.

### BRIEF DESCRIPTION OF DRAWINGS

FIG. 1 is a block diagram depicting an exemplary embodiment of a multi-task relationship learning system according to the present invention.

FIG. 2 is a flowchart depicting an operation example of the multi-task relationship learning system.

FIG. 3 is a block diagram depicting an overview of the multi-task relationship learning system according to the present invention.

FIG. 4 is a schematic block diagram depicting a structure of a computer according to at least one exemplary embodiment.

FIG. 5 is an explanatory diagram depicting an operation example of estimating prediction models by multi-task relationship learning.

FIG. 6 is an explanatory diagram depicting an example of a matrix indicating generated prediction models.

FIG. 7 is a flowchart depicting an operation example of multi-task relationship learning.

### DESCRIPTION OF EMBODIMENT

An exemplary embodiment of the present invention will be described below, with reference to drawings. In the following description, prediction targets are also referred to as tasks.

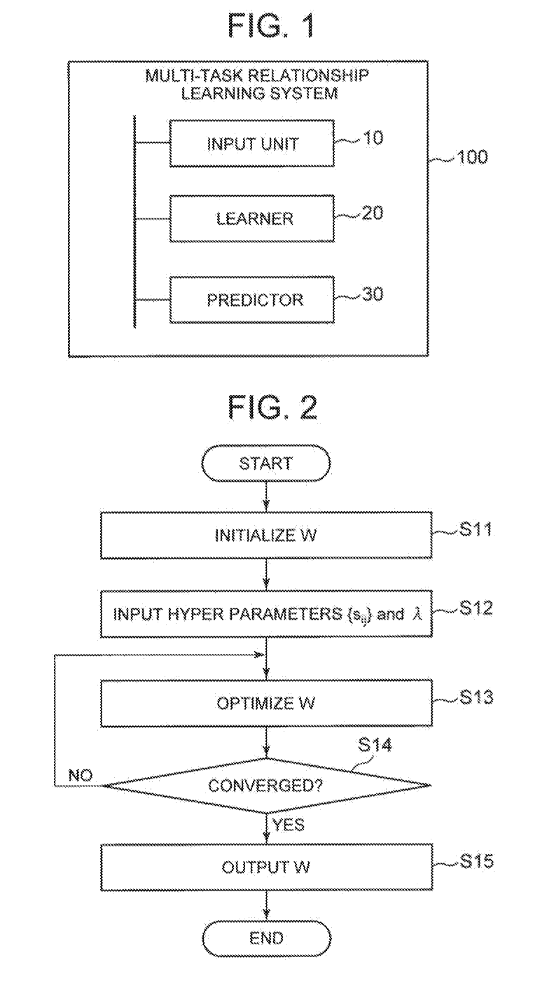

FIG. 1 is a block diagram depicting an exemplary embodiment of a multi-task relationship learning system according to the present invention. A multi-task relationship learning system 100 in this exemplary embodiment includes an input unit 10, a learner 20, and a predictor 30.

The input unit 10 receives input of various parameters and learning data used for learning. The input unit 10 may receive input of these information through a communication network (not depicted), or receive input of these information by reading the information from a storage device (not depicted) storing the information.

The learner 20 simultaneously estimates a plurality of prediction models. Specifically, the learner 20 optimizes the prediction models so as to minimize a function that includes a sum total of errors indicating consistency with data and a regularization term deriving sparsity relating to differences between the prediction models. The learner 20 estimates the prediction models by such optimization.

The regularization term deriving sparsity denotes a regularization term that can be used to optimize the number of nonzero values. Here, L0 norm, i.e. the number of nonzero values, is to be optimized in the first place. If L0 norm is directly optimized, however, the problem is not a convex optimization problem but a combinational optimization problem, and computational complexity increases. In view of this, for example by relaxing the problem to a convex optimization problem very close to the original problem using L1 norm, sparsity is facilitated without increasing computational complexity. Specifically, the regularization term is calculated as the sum total of the norms of the differences between the prediction models.

A function f optimized by the learner 20 is defined, for example, within the parentheses in the following Expression 3. In Expression 3, the first term (Σ error) is the sum total of errors indicating consistency with data, and corresponds to the square error in multi-task learning. The second term is the sum total of the norms of the differences between the prediction models, and functions as the regularization term. In Expression 3, a prediction model corresponding to one task (prediction target) is represented by a vector w.

$$\begin{matrix}[ Math . 3 ] & \\ {min}_{W} \{ \sum error + λ {\sum }_{i \neq j} {s}_{ij} {‖ {w}_{i} - {w}_{j} ‖}_{p} \} & Expression ( 3 )\end{matrix}$$

In Expression 3, λ, is a parameter indicating an effect of making prediction models closer to each other between tasks. When λ, is higher, this effect is stronger. p is set to, for example, 1 or 2. That is, L1 norm or L2 norm is used as the norm of the regularization term. The norm used is, however, not limited to L1 norm or L2 norm.

sᵢⱼ is a value given as external knowledge, and is any weight value set for the norm of the i-th prediction model and the j-th prediction model. For example, in the case where there is a pair of prediction models {i,j} that can be assumed to form similar clusters beforehand, sᵢⱼ is set to a large value. In the case where the relationship between the prediction models is not clear, sᵢⱼ can be set to 1.

By calculating the regularization term as the sum total of norms multiplied by the weight value corresponding to the assumed similarity between the prediction models, the accuracy of the estimated prediction models can be further improved.

For example, in demand prediction for new stores, not much learning data is available. It is therefore preferable to intensify the regularization parameter (i.e. increase the value of λ) to enable more aggregation of prediction models. Accordingly, λ, representing the regularization intensity may be, for example, determined depending on the number of samples. The regularization intensity may be determined by using other data (e.g. using a method such as cross validation).

For example, in the case of the existing learning method described in NPL 1, a term indicating closeness of prediction models has the relationship represented by the following Expression 4.

[Math. 4]

λ₁tr(W^{T}QW)=λ₁Σ−Qᵢⱼ∥ [symbol] ₁− [symbol] ₂∥₂². Expression (4)

As can be seen from Expression 4, the existing learning method differs significantly from this exemplary embodiment in that the square of the norm is calculated. In the case where the norm is not the square as in Expression 3, the shape of corresponding part in the objective function is a cone having, as the apex, a point at which the contents of ∥⋅∥=0. For example, in the case of L2 norm (p=2), the shape is a circular cone. In the case of L1 norm (p=1), the shape is a quadrangular pyramid.

The shape of the Σ error included in the objective function subjected to optimization is typically a smooth function. For example, in the case where the Σ error is a square error, its shape is a secondary function for the matrix W representing the plurality of prediction models.

In this exemplary embodiment, by calculating the sum of the Σ error and the sum total of the p norms of the prediction models, it facilitates to obtain the result that the optimization result is likely to be a sharp part such as the apex of a cone. Specifically, a prediction model group such that ∥wᵢ−wⱼ∥ₚ=0 is likely to be obtained. This has an effect of facilitating coincidence of models even when clusters are not clearly assumed.

The objective function in this exemplary embodiment is a non-smooth convex function. However, such optimization can be performed at relatively high speed through the use of an optimization technique relating to L1 regularization (Lasso). A simple example of the optimization is a subgradient method.

With the subgradient method, for a point that is sharp and for which a gradient cannot be defined, a gradient is randomly determined from a set of possible gradients. With the subgradient method, for example, update is performed using the following Expression 5.

$$\begin{matrix}[ Math . 5 ] & \\ {G}_{C} = \frac{1}{\vert C \vert} {\sum }_{i ∈ C} \frac{\partial l}{\partial {w}_{i}} + \frac{λ}{\vert C \vert} {\sum }_{j ∉ C} {s}_{jC} \frac{{w}_{C} - {w}_{j}}{{‖ {w}_{C} - {w}_{j} ‖}_{p}} & Expression ( 5 )\end{matrix}$$

In Expression 5, C is a set of completely coincident i, and wᵢ=w_{C} for all i∈C. G_{C} is a subgradient used in optimization of 1 step, and is a candidate group in the direction in which the optimization of w proceeds. 1 corresponds to the square error in multi-task learning.

Although the subgradient method is described as an example of the method of optimization by the learner 20, the optimization method is not limited to the subgradient method.

The predictor 30 predicts each task using the estimated prediction model.

The input unit 10, the learner 20, and the predictor 30 are implemented by a CPU of a computer operating according to a program (multi-task relationship learning program). For example, the program may be stored in a storage unit (not depicted) in the multi-task relationship learning system, with the CPU reading the program and, according to the program, operating as the input unit 10, the learner 20, and the predictor 30.

The input unit 10, the learner 20, and the predictor 30 may each be implemented by dedicated hardware. The multi-task relationship learning system according to the present invention may be formed by wiredly or wirelessly connecting two or more physically separate devices.

Operation of the multi-task relationship learning system in this exemplary embodiment will be described below. FIG. 2 is a flowchart depicting an operation example of the multi-task relationship learning system in this exemplary embodiment. In this operation example, the learner 20 performs a process of optimizing the foregoing Expression 3.

The learner 20 initializes W (step S11). The input unit 10 receives input of hyper parameters {sᵢⱼ} and λ, (step S12). The learner 20 optimizes W based on the input hyper parameters (step S13). Specifically, the learner 20 optimizes W so as to minimize the foregoing Expression 3, to estimate the prediction models

The learner 20 determines the convergence of the optimization process based on the update width, the lower limit variation, and the like (step S14). In the case where the learner 20 determines that the optimization process has converged (step S14: Yes), the learner 20 outputs W (step S15), and ends the process. In the case where the learner 20 determines that the optimization process has not converged (step S14: No), the learner 20 repeats the process from step S13.

As described above, in this exemplary embodiment, the learner 20 optimizes prediction models so as to minimize a function that includes a sum total of errors indicating consistency with data and a regularization term indicating a sum total of norms of differences between the prediction models, to estimate the prediction models. Thus, the accuracy of a plurality of estimated prediction models can be improved while reducing computational complexity in prediction model learning.

In the multi-task relationship learning system in this exemplary embodiment, prediction models similar in tendency are learned as close models. This can be regarded as clustering of prediction models. The clustering herein denotes clustering in a space (by w vector) having each prediction model as one point, and differs from typical clustering in a feature space representing each feature.

For example, with the learning method described in NPL 1, the order of computational complexity of each optimization step is the order of the cube of the number of tasks (O((the number of tasks)³)), and the order of memory required is the order of the square of the number of tasks (O((the number of tasks)²)). According to the present invention, on the other hand, as a result of not having clear relationships, the order of computational complexity of each optimization step is the order of the square of the number of tasks (O((the number of tasks)²)) in the case of typical Lp norm, and the pseudo-linear order of the number of tasks (O((the number of tasks)log(the number of tasks))) in the case of L1 norm. The order of memory required is the order of the number of tasks (O(the number of tasks)).

In the case where the present technique is used in a situation in which the number of tasks is very large, the log part can be mostly ignored. Thus, the present technique that can perform calculation of the pseudo-linear order has sufficient effects as compared with the learning method described in NPL 1. The present invention therefore achieves more remarkable effects than in the case where a computer is operated based on the existing method.

The reason why calculation of the pseudo-linear order is possible is as follows. When calculating a gradient at some point in an optimization process, for a value (wᵢⱼ) corresponding to each feature of each task of a model, only “at which ordinal position the i-th task is among all tasks” for the feature j contributes to the value of the gradient for the regularization term. Since sorting can be typically executed by T log T where T is the number of tasks, executing a sort algorithm for each feature j enables calculation of the foregoing order.

Thus, the multi-task relationship learning method according to the present invention functions differently from the existing learning method, and the present invention is intended for functional improvement (performance improvement) of computers, i.e. intended for special implementation for solving problems in software technology.

For example, the present invention can be applied to a situation in which each store Sₙ has a prediction model Wₙ for commodity demand and each prediction model Wₙ is to be optimized. It is assumed that the fit to data does not deteriorate much even when, for example, the prediction model W₁ of the store S₁ and the prediction model W₂ of the store S₂ are combined as one prediction model.

In such a case, by optimizing the foregoing Expression 3, the prediction model W₁ and the prediction model W₂ can be combined as one prediction model. As a result of simultaneously optimizing a plurality of prediction models and aggregating (clustering) the prediction models into fewer prediction models in this way, data used to learn each prediction model can be shared, so that the performance of each prediction model can be improved.

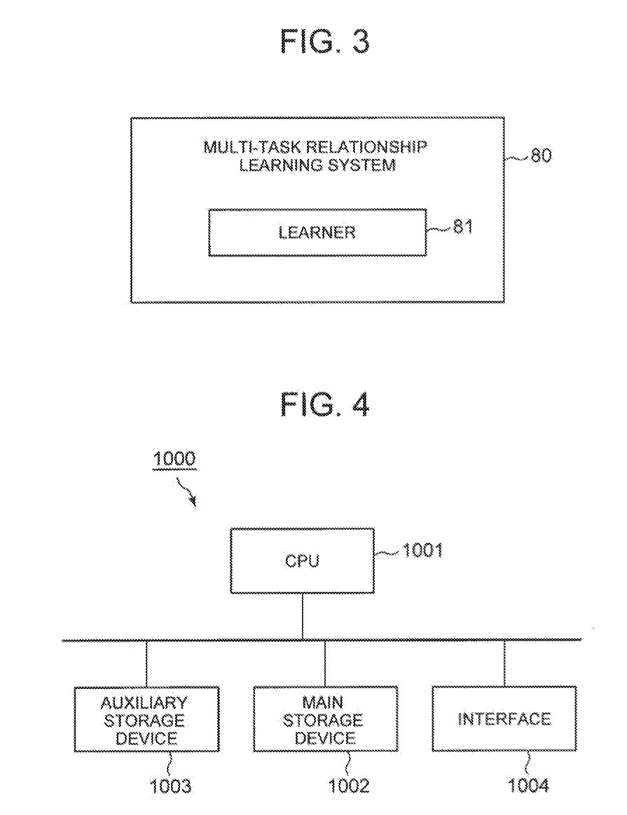

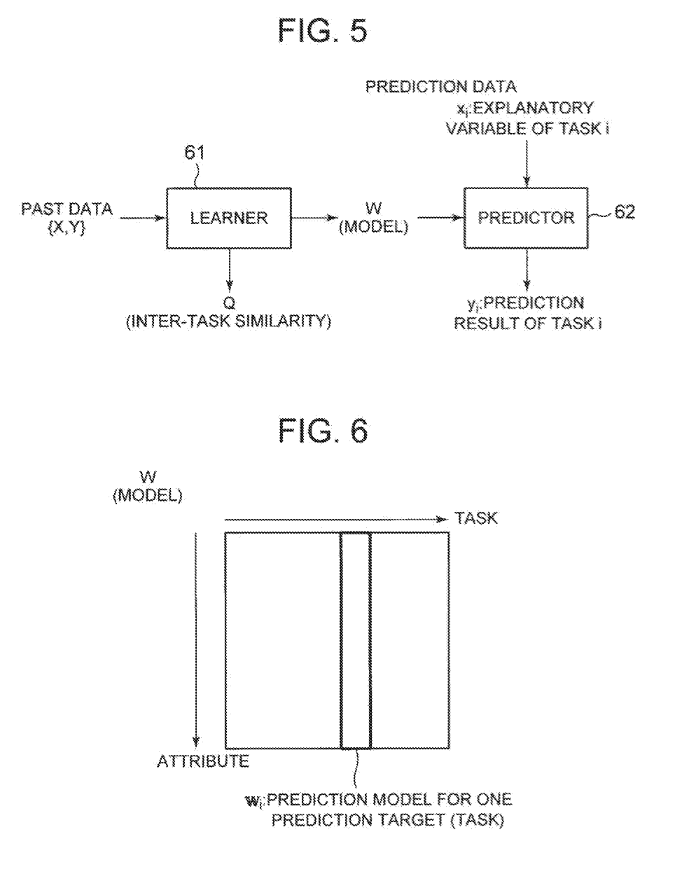

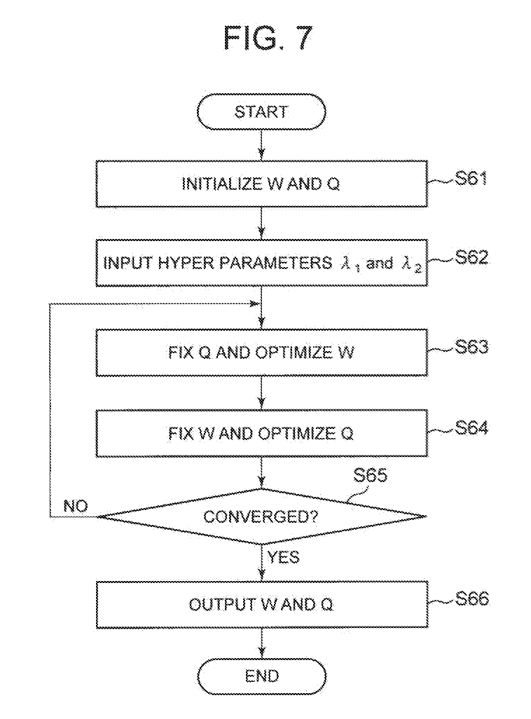

An overview of the present invention will be given below. FIG. 3 is a block diagram depicting an overview of the multi-task relationship learning system according to the present invention. The multi-task relationship learning system according to the present invention is a multi-task relationship learning system 80 (e.g. the multi-task relationship learning system 100) for simultaneously estimating a plurality of prediction models, and includes a learner 81 (e.g. the learner 20) which optimizes the prediction models so as to minimize a function that includes a sum total of errors (e.g. the first term in Expression 3) indicating consistency with data and a regularization term (e.g. the second term in Expression 3) deriving sparsity relating to differences between the prediction models, to estimate the prediction models.

With such a structure, the accuracy of a plurality of estimated prediction models can be improved while reducing computational complexity in prediction model learning.

Specifically, the regularization term may be calculated as a sum total of norms of the differences between the prediction models.

The regularization term may be calculated as a sum total of norms multiplied by a weight value (e.g. sᵢⱼ in Expression 3) corresponding to assumed similarity between the prediction models. By calculating the regularization term as the sum total of norms multiplied by the weight value, the accuracy of the estimated prediction models can be improved. In the case where the relationship between the prediction models is not clear, the weight value can be set to 1.

A norm of the regularization term may be L1 norm or L2 norm.

The learner 81 may optimize the prediction models using a subgradient method.

FIG. 4 is a schematic block diagram depicting a structure of a computer according to at least one exemplary embodiment. A computer 1000 includes a CPU 1001, a main storage device 1002, an auxiliary storage device 1003, and an interface 1004.

The multi-task relationship learning system described above is implemented by the computer 1000. The operation of each processing unit described above is stored in the auxiliary storage device 1003 in the form of a program (multi-task relationship learning program). The CPU 1001 reads the program from the auxiliary storage device 1003, expands the program in the main storage device 1002, and executes the above-described process according to the program.

In at least one exemplary embodiment, the auxiliary storage device 1003 is an example of a non-transitory tangible medium. Examples of the non-transitory tangible medium include a magnetic disk, magneto-optical disk, CD-ROM, DVD-ROM, and semiconductor memory connected via the interface 1004. In the case where the program is distributed to the computer 1000 through a communication line, the computer 1000 to which the program has been distributed may expand the program in the main storage device 1002 and execute the above-described process.

The program may realize part of the above-described functions. The program may be a differential file (differential program) that realizes the above-described functions in combination with another program already stored in the auxiliary storage device 1003.

### INDUSTRIAL APPLICABILITY

The present invention is suitable for use in a multi-task relationship learning system for simultaneously learning a plurality of tasks. The present invention is particularly suitable for learning of prediction models for targets without much data, such as demand prediction for new commodities.

### REFERENCE SIGNS LIST

10 input unit
20 learner
30 predictor
100 multi-task relationship learning system

What is claimed is:

1. A multi-task relationship learning system for simultaneously estimating a plurality of prediction models, the multi-task relationship learning system comprising:
a hardware including a processor; and
a learner, implemented by the processor, which optimizes the prediction models so as to minimize a function that includes a sum total of errors indicating consistency with data and a regularization term deriving sparsity relating to differences between the prediction models, to estimate the prediction models.

2. The multi-task relationship learning system according to claim 1, wherein the regularization term is calculated as a sum total of norms of the differences between the prediction models.

3. The multi-task relationship learning system according to claim 1, wherein the regularization term is calculated as a sum total of norms multiplied by a weight value corresponding to assumed similarity between the prediction models.

4. The multi-task relationship learning system according to claim 1, wherein a norm of the regularization term is L1 norm or L2 norm.

5. The multi-task relationship learning system according to claim 1, wherein the learner optimizes the prediction models using a subgradient method.

6. A multi-task relationship learning method for simultaneously estimating a plurality of prediction models, the multi-task relationship learning method comprising
optimizing the prediction models so as to minimize a function that includes a sum total of errors indicating consistency with data and a regularization term deriving sparsity relating to differences between the prediction models, to estimate the prediction models.

7. The multi-task relationship learning method according to claim 6, wherein the regularization term is calculated as a sum total of norms of the differences between the prediction models.

8. A non-transitory computer readable information recording medium storing a multi-task relationship learning program for use in a computer for simultaneously estimating a plurality of prediction models, the multi-task relationship learning program, when executed by a processor, performs a method for
optimizing the prediction models so as to minimize a function that includes a sum total of errors indicating consistency with data and a regularization term deriving sparsity relating to differences between the prediction models, to estimate the prediction models.

9. The non-transitory computer readable information recording medium according to claim 8, wherein the regularization term is calculated as a sum total of norms of the differences between the prediction models.
